(19) United States
(12) Patent Application Publication
(10) Pub. No.: US 2016/0063504 A1
(43) Pub. Date: Mar. 3, 2016

(54) METHOD AND SYSTEM FOR IMPLEMENTING BIOMETRIC AUTHENTICATED TRANSACTIONS

(71) Applicant: MobiCash Hong Kong Ltd, Hong Kong (CN)

(72) Inventor: Patrick G. Ngabonziza, Johannesburg (ZA)

(73) Assignee: MobiCash Hong Kong Ltd., Hong Kong (CN)

(21) Appl. No.: 14/839,225

(22) Filed: Aug. 28, 2015

Related U.S. Application Data
(60) Provisional application No. 62/043,019, filed on Aug. 28, 2014.

(51) Int. Cl. G06Q 20/40; G06K 9/00

(52) U.S. Cl. CPC G06Q 20/40145; G06K 9/00013; G06K 9/00087

(57) ABSTRACT

Disclosed is a method and system for implementing biometric authenticated transactions for sale and purchase of various services or products. The system includes a computing device having a user interface for selecting at least one service or product required by the user, a biometric reader capable of capturing and sending biometric information of the user and a server which is adapted to communicate with the biometric reader through the at least one computing device. The server includes a biometric information database and a matching module which is adapted to receive the biometric information of the user and authorize the transaction based on result of matching of the biometric information of the user with the information stored in the database.

### CROSS-REFERENCE TO RELATED APPLICATIONS

This application claims the benefit of U.S. Provisional Application No. 67/043,019, filed on Aug. 28, 2014, the teachings of which are expressly incorporated by reference.

### FIELD OF THE DISCLOSURE

This invention relates to the field of financial transactions. More specifically, this invention is directed towards a system and method for implementing biometric authenticated transactions.

### BACKGROUND OF THE DISCLOSURE

Biometric payment technology has become a mature technology and can actually support financial applications in the real banking world. Many believe that the technology is a viable replacement for, or enhancement to, the use of passwords or PINs to verify the identity of a person.

The premise of biometric authentication is that each person's characteristics are unique to that individual. Even identical twins do not have the exact same characteristics. Also it is very hard to misplace, and impossible to forget the personal characteristics, since they are a physical part of each individual.

There is nothing particularly new about recognizing a person by their physical and behavioral characteristics, from the way they look and sign their name, to the sound of their voice and the patterns of their fingerprint. In fact, this concept has played a central role in how society functions since time immemorial. What has changed, though, is that globalization and technology are now driving the international impetus to replace these fairly rudimentary methods with more sophisticated identification and verification techniques which can be carried out by devices capable of remembering thousands and even millions of identities. And a big advantage of these latest digital methods of identifying an individual is that they are not hindered by human error.

One of the most common biometrics used for identification is the fingerprint, which has been used over the centuries as a means of verification. Fingerprints are the little ridges on the end of your fingers and thumb. They are arranged in a pattern of spirals and loops. Nature evolved these to help us grip and hold on to things. The texture prevents things from slipping and sliding as would naturally happen if our skin were smooth, and especially if our hands are wet or sweaty.

In today's world new payment technologies are required to ease the tension of conventional payment systems, especially in online space. The conventional payment systems usually require a user to go through the tension of using cards and to memorize or document theirs difficult passwords and pin numbers while making payments.

In daily life a person has to carry and use various cards ranging from credit cards, check card for shopping, bus card, mass transport card for traveling, student card for library and department, and many kinds of cards for unlimited purposes and so on. The problem is that a person has to take many cards and has to remember their passwords or secret codes and to keep secure to take with him all time.

Moreover, these payment systems are subject to manipulation and fraud, especially in online space. Many times credit card and bank information gets compromised leading to huge losses of money and mental agony for the victims of fraud.

On the other hand, a biometric based payment system could be much safer and secure system, which is very easy to use without using any password or secret codes to remember as compare with previous system like credit or debit card payment system, wireless system and mobile system etc. Therefore, there is a need of using these biometric payment systems in day to day transactions, especially in online space.

### SUMMARY OF THE DISCLOSURE

In view of the foregoing disadvantages inherent in the prior-art and the needs as mentioned above, the general purpose of the present disclosure is to provide a system and method for carrying biometric authenticated transactions that is configured to include all advantages of the prior art and to overcome the drawbacks inherent in the prior art offering some added advantages.

To achieve the above objectives and to fulfill the identified needs, in one aspect, the present disclosure provides a system for implementing biometric authenticated transactions for sale and purchase of various services or products in an online environment.

The system includes a computing device having a user interface for selecting at least one service or product required by a user especially in an online environment. Further, the system includes a biometric reader device which is adapted to communicate with said computing device. The biometric reader is capable of capturing and sending biometric information of the user. In one embodiment, the biometric reader includes a fingerprint reader capable of capturing fingerprints of the user. In one embodiment, the biometric reader is adapted to apply a non-reversible compression to the biometric information of the user.

The system further includes a server which is adapted to communicate with the at least one biometric reader through the at least one computing device. Further, the server includes a biometric information database for storing biometric information of users. Furthermore, the server includes a matching module which is adapted to communicate with the biometric information database and said computing device, wherein said matching module is adapted to authorize the transaction based on matching of the biometric information of the user with the information stored in the database.

In one embodiment, the server further includes a processing module adapted to process the transaction after authorization of the transaction by the matching module, wherein the processing of the transaction comprises settling the transaction with a financial institution.

In one embodiment, the system further includes financial information a the users pre-stored in a database for using the financial information of the user during processing of the transaction. In one embodiment, the financial information includes credit card information, bank account information and personal information of the users, wherein the financial information of the user is used for payment of the service or product required by the user.

In another aspect, the present invention provides a method for implementing biometric authenticated transactions for sale and purchase of various services or products.

The method includes receiving a transaction request for at least one service or item from a user through a user computing device. Further, the method includes receiving biometric information of the user through at least one biometric reader connected to the said computing device, wherein the biometric reader is adapted to capture the biometric information of the user. Furthermore, the method includes retrieving pre-stored biometric information of said user from a biometric information database, and matching the user biometric information with the pre-stored biometric information. Furthermore, the method includes authorizing the received transaction request based on results of matching of the biometric information, and processing and confirming the transaction to the user.

This together with the other aspects of the present invention along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### BRIEF DESCRIPTION OF THE DRAWINGS

The advantages and features of the present disclosure will become better understood with reference to the following detailed description and claims taken in conjunction with the accompanying drawing, in which:

FIG. 1 illustrates a schematic diagram of biometric authenticated transactions system, according to various embodiments of the present invention;

FIG. 2 illustrates a block diagram for implementing biometric authenticated transactions, according to various embodiments of the present invention;

FIGS. 3 and 4 illustrate various implementations or the biometric authenticated transactions system, according to various embodiments of the present invention;

FIG. 5 illustrates a schematic diagram of the transaction flow for the biometric authenticated transactions system of the present invention, according to various embodiments of the present invention; and

FIG. 6 illustrates a flow diagram of how a biometric payment transaction may happen in an online platform, according to various embodiments of the present invention.

Like numerals refer to like elements throughout the present disclosure.

### DETAILED DESCRIPTION OF THE DISCLOSURE

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

The terms “a” and “an” herein do not denote a limitation of quantity, but rather denote the presence of at least one of the referenced item.

The terms “having”, “comprising”, “including”, and variations thereof signify the presence of a component.

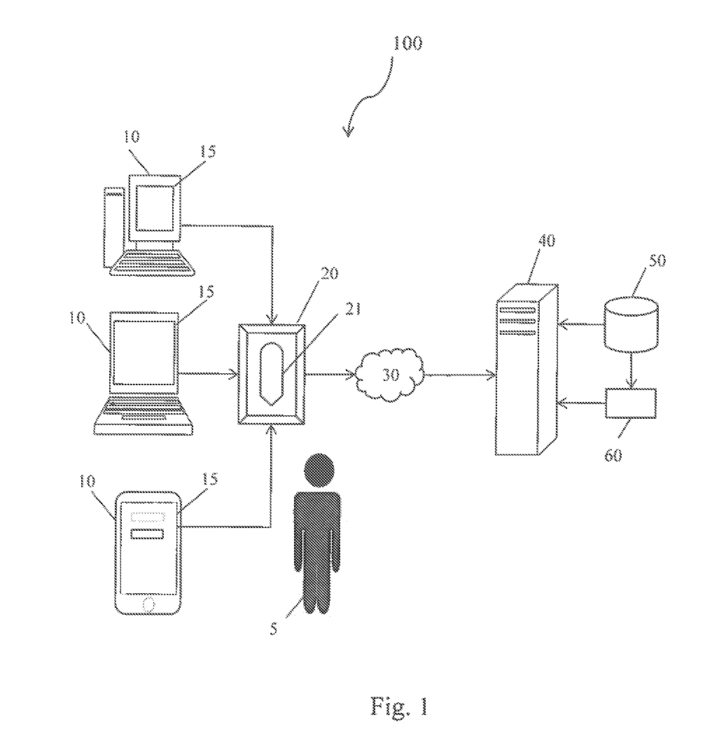

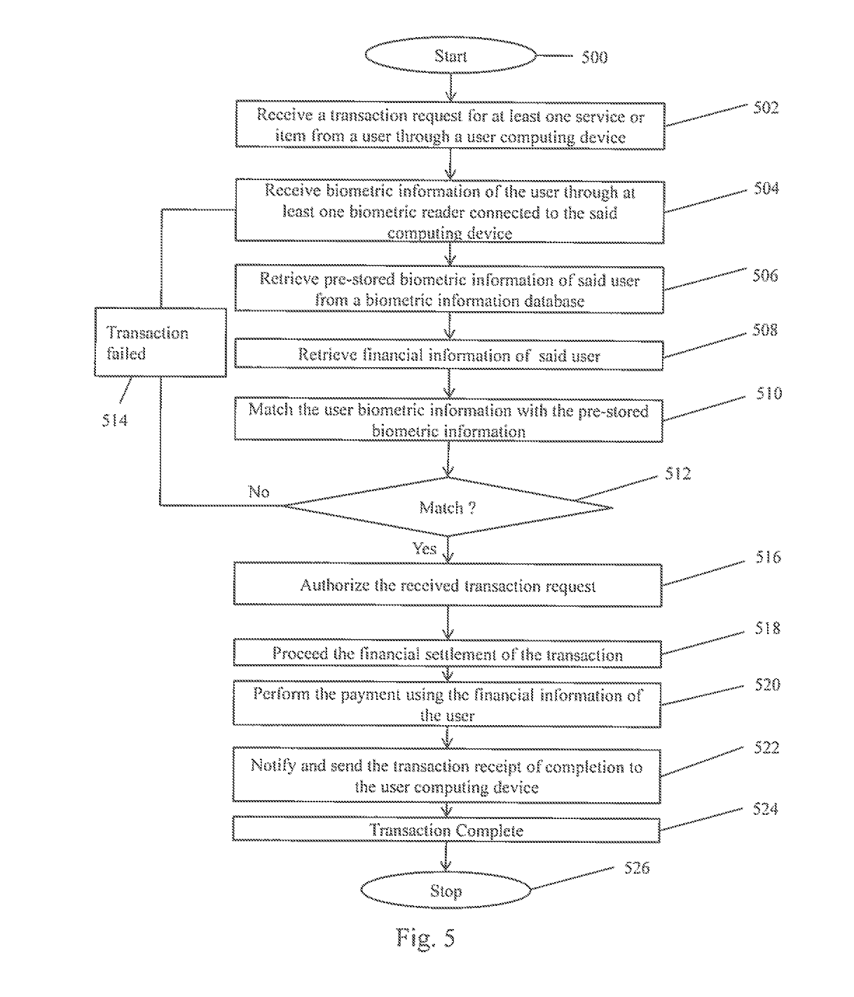

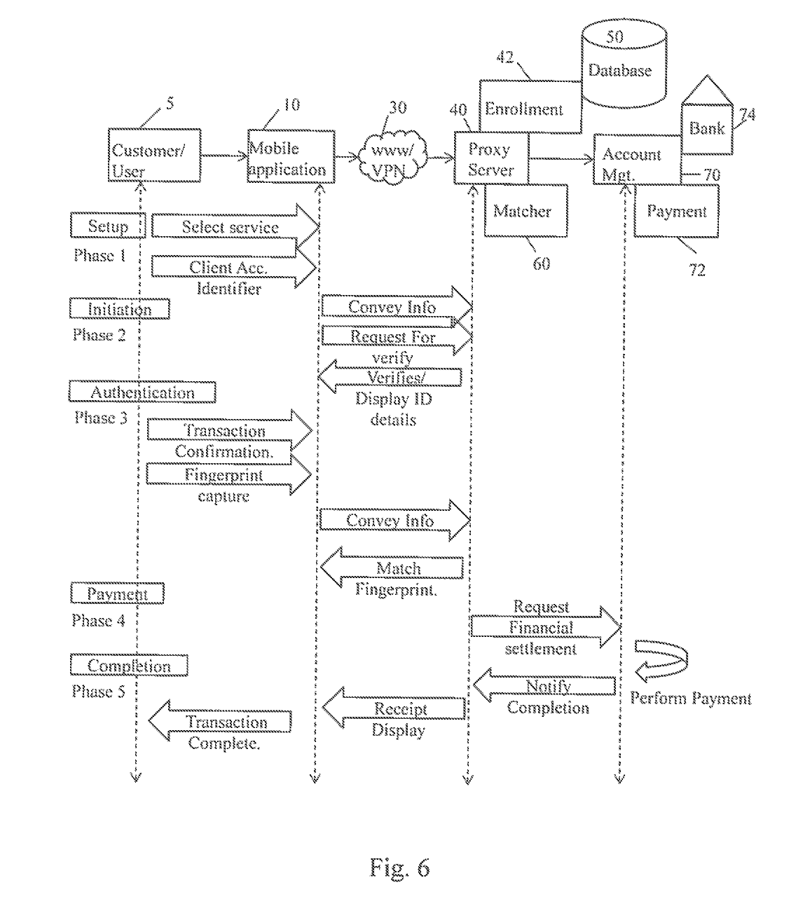

The present invention provides a system and method for implementing biometric authenticated transactions for various services or products, especially in an online environment. The biometric authenticated transactions system and its usage are described with reference to FIGS. 1-4, whereas the method of for implementing biometric authenticated transactions for sale and purchase of various services or items in an online environment is shown with reference to FIGS. 5 and 6.

It should be apparent to a person skilled in the art that the term “biometric reader” as referenced herein refers to an electronic device that allows an individual to make electronic commerce transactions through fingerprint or biometric information of the individual. Further, the transactions may include peer to peer transfer of currency, purchasing items in a Point of Sale (POS) or transacting with the POS for transfer of money or purchase of products or items.

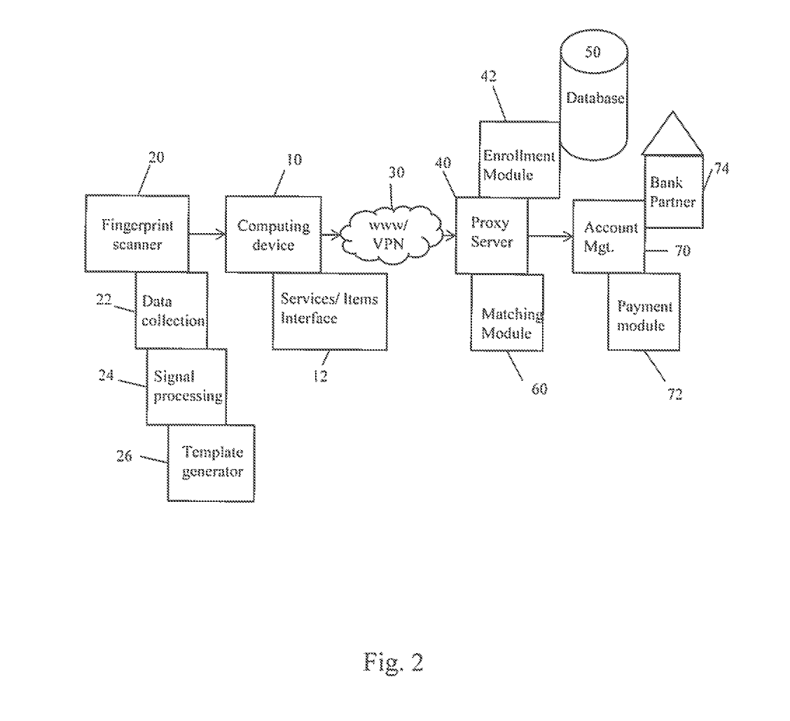

Referring to FIGS. 1 and 2, there is shown a system 100 for implementing biometric authenticated transactions for sale and purchase of various services or items in an online environment. The system includes a computing device 10 [e.g. a computer, a laptop, a tablet or mobile phone, smartphone, and the like] having a user interface 15 for selecting or accessing at least one service or items 12 (as shown in FIG. 2) required by a user 5.

The examples of service or items 12 includes, but are not limited. to, various m-banking and m-payment services, ranging from cash deposits, cash withdrawals, cash transfers, and e-payments for goods, services, utilities, etc., which are typically consumed by various customers in an online space these days.

Further, the system includes a biometric reader device 20 adapted to communicate with said at least one computing device 10 via wired or wireless communication means. The biometric reader 20 is capable of capturing and sending biometric information of the user 5.

In one embodiment, the biometric information includes user's behavioral or physiological characteristic. Examples of behavioral or physiological characteristic include, but not limited to fingerprints, palm veins, face recognition, DNA, palm prints, hand geometry, iris recognition, retina and odour/scent. Behavioral characteristics are related to the pattern of behavior of a person, including but not limited to typing rhythm, gait, and voice. In one embodiment, the biometric reader 20 is a finger print reader 20 capable of reading finger prints of the user 5.

In one embodiment of the present invention, the biometric reader 20 includes various sensors (not shown) fair capturing biometric information of the user. It can be appreciated that the biometric reader 20 is provided with a sensor area 21 from which the Fingerprint of a user is scanned with a swiping motion thereon. Other alternate fingerprint sensors/scanners 21 commercially available could replace/alter the illustrated sensor area 21 without departing from the scope of the present invention.

In one embodiment of the present invention, the biometric reader 20 includes a data collection module (not shown) which is adapted to collect the biometric information data from the sensor 21.

Further, in one embodiment, the biometric reader 20 includes a signal processing module (not shown) adapted to control the quality of signal received from the data collection module. The biometric reader 20 further includes a template generator adapted to create a template based on the biometric information of the user 5.

In one embodiment of the present invention, the biometric reader 20 is adapted to apply a non-reversible compression to the biometric information of the user. The non-reversible compression ensures that the biometric image or data cannot be reconstructed from the extracted biometric information for security purpose. This allows encryption of the biometric information of the user 5. In one embodiment, the biometric reader 20 transforms points of the captured fingerprint into a mathematical formula so the full image of the fingerprint is not actually stored in the system 100 preventing hackers from stealing the fingerprint.

Again referring to FIGS. 1 and 2, the system include a server 40 adapted to communicate with the biometric reader 40 through the at least one computing device 10 via a communication channel 30.

In one embodiment, the communication channel 30 is wired or wireless and may include, but not limited to, at least one of a cellular telephone network, a satellite network, a virtual private network, and the Internet.

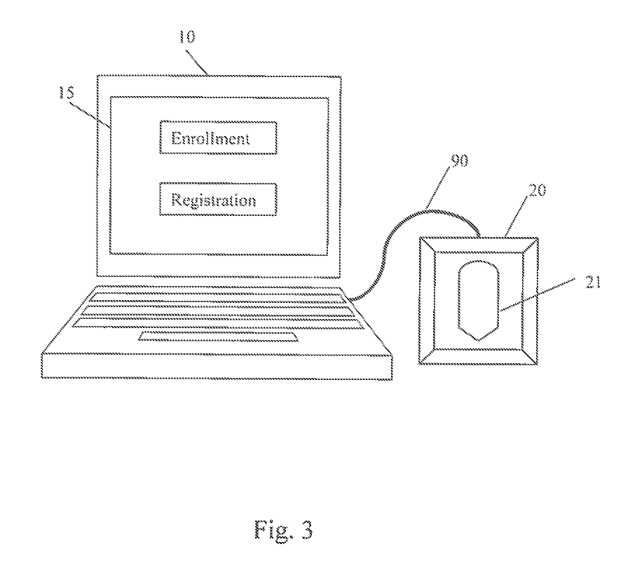

In one embodiment of the present invention, the server 40 includes a biometric information database 50. This database 50 is a compilation of biometric information of pre-registered users. In other words, the users using the system 100 are required to enroll their biometric information for accessing the services, and the biometrics are stored in the database 50, as shown in FIG. 3.

In one embodiment of the present invention, the server 40 includes a matching module 60 adapted to communicate with the biometric information database 50 and the computing device 10 of the user 5.

The said matching module 60 is adapted to receive the biometric information of the user 5 through the communication channel 30, and match the biometric information so received with the biometric information pre-stored in the database 50 against the user 5. More specifically, the matching module 60 parses the database 50 for the user 5, locates the biometric information stored against the user 5, and compares or matches the stored information with the biometric information received on the server 40.

The matching module 60 authorizes the transaction based on result of matching of the biometric information of the user with the information stored in the database 50. In one embodiment, the matching module 60 may accept the transaction in case of positive match. In another embodiment, the matching module 60 may decline the authorization if there is a negative match of the biometric information.

The server 40 further comprises a processing module (not shown) adapted to process the transaction after authorization of the transaction by the matching module 60. The processing of the transaction includes settling the transaction with a financial institution 74, such as a merchant bank, microfinance bank, or credit institution and the like.

In one embodiment of the present invention, the server 40 includes a database (not shown) for pre-storing financial information of the users. The financial information of the user is used during processing of the transaction, and more specially to settle payments against the required purchase or transaction against the service or product.

In one embodiment, the financial information includes credit card information, such as the credit card number, expiry date, CVV number and the like. The financial information may also include bank account information, such as bank name, account number, and other authenticating passwords, and personal information of the users. As mentioned above, the financial information of the user is used for payment of the service or item 12 required by the user 5.

FIG. 5 illustrates a method for implementing biometric authenticated transactions for sale and purchase of various services or products by a user 5.

The method initiates at step 500. Thereafter, the method moves to step 502. At step 502, the method receives a transaction request for at least one service or product from a user through a user computing device, such as user computing device 10.

At step 504, the method includes receiving biometric information of the user through at least one biometric reader, such as biometric reader 20, connected to the said computing device. The biometric reader is adapted to capture the biometric information of the user.

The method further includes retrieving pre-stored biometric information of said user from a biometric information database, such as database 50, at step 506. Thereafter, the method includes retrieving financial information of the user at step 508, and at step 510 comparing the retrieved biometric information from the database at step 506 with the biometric information received at step 504.

Thereafter, the method flows to decision box 512. At 512, the method decides the match. If there is a positive match, the method moves to step 516, where the transaction is authorized. On the other hand, if the match is negative, the method flows to step 514, the user is notified that the transaction has failed, and then the method flows back to step 504.

Thereafter, the method processes and confirms the transaction to the user, and more specifically, the method proceeds with financial settlement of the transaction at step 518, followed by performing the payment using the financial information of the user, at step 520. The method then notifies the user art step 522, and the transaction is completed at step 524, and the flow stops.

FIG. 6 illustrates a flow diagram of biometric authenticated transactions for sale and purchase of various services or items in an online platform. The present system 100 allows a user/customer 5 to select a service or item 12 through the user computing device 10 and send a transaction request to the server 40, in set up phase.

The transaction request includes selected service or item details and ID details of the user 5. The system 100 is adapted to send the transaction request to the server 40 in the is process as shown in FIG. 5. Thereafter, the server 40 is adapted to identify and verify the account details of the user 5 in the initiation process. After initiation process, the server 40 is adapted to receive a transaction confirmation request from the user 5 as shown in the figures.

The server 40 then receives biometric information of the user through at least one biometric reader 28 connected to the said computing device via communication channel 30. The transaction confirmation request includes the amount user would like to transact for the selected service or item 20. The information may be encrypted by the biometric reader 20 as described in foregoing description.

The system 100 then moves to the authentication phase, where the server 40 may then match the biometric information with the information in the database 50 to decide on the authorization.

In case there is a match of the biometric information, the server 40 may then authorize the payment and initiate the payment phase, where the request for financial settlement may be send to the bank, and the corresponding payment may be performed. The system 100 then moves into completion phase, where the user 5 is notified, and the receipt is displayed on the user computing device 10. The transaction may then culminate and the completion phase ends.

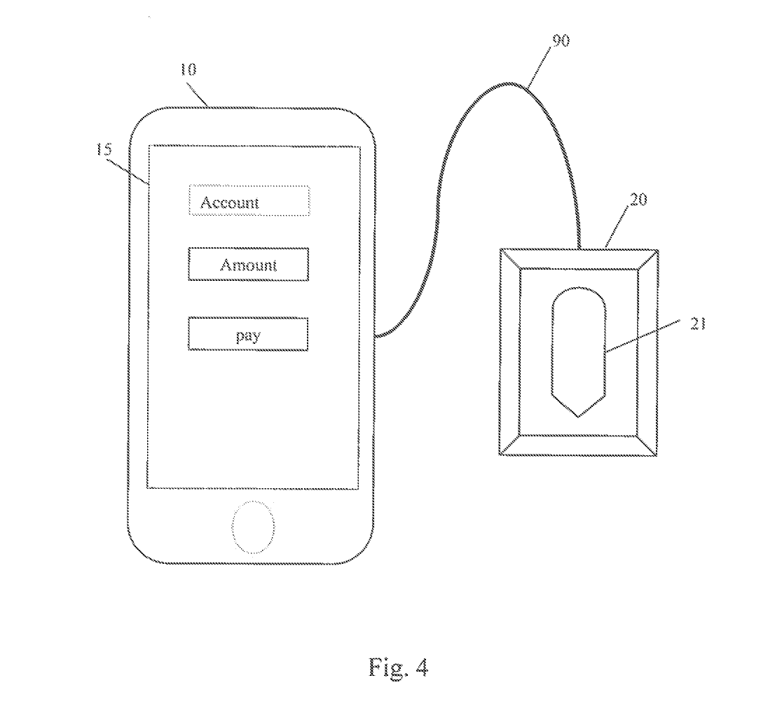

In various embodiment of the preset invention, the user can perform biometric authenticated transaction en a mobile device. As shown in FIG. 4, there is a mobile device adapted to connect via communication medium 90 to the biometric reader 28 for performing various online transactions, wherein the communication medium is a USB cable, Ethernet cable, HDMI cable. Further, the mobile phone 10 and biometric reader both are capable communicating through wireless medium.

The system and method of the present invention has various advantages. Firstly, monetary transactions can be done exclusively with the account owner's fingerprint without the need of cash or any card. Secondly, there is no more need for usernames and passwords for online-banking. A small portable fingerprint reader can be connected to any computer. The biometric reader device may be given by banks and customers. In the long run, the invention aims to standardize the fingerprint reader as a usual feature on any computer, so that it would be already included and doesn't have to be connected separately any longer.

Moreover, shops will be provided with fingerprint readers. This assures the easy usage of fingerprint-banking. At shopping, you only need to leave your fingerprint to pay, without entering a code or giving a signature, which will be easy and fast.

The invention allows a safer, easier, faster and more efficient paying process. Banks should expect the rate of robberies to decline drastically since IS people are not required to carry any more cash or credit cards with them. Also, it is much easier for the consumers as they don't have to worry about having cash with them or remembering their credit card code.

The system, as described in the disclosed teachings or any of its components, may be embodied in the form of a computer system. Typical examples of a computer system include a general-purpose computer, a PDA, a cell phone, a programmed microprocessor, a micro-controller, a peripheral integrated circuit element, and other devices or arrangements of devices that are capable of implementing the steps that constitute the method of the disclosed teachings.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed is:

1. A system for implementing biometric authenticated transactions for sale and purchase of various services or items, the system comprising:
a computing device having a user interface for selecting at least one service or product required by a user;
at least one biometric reader device adapted to communicate with said at least one computing device, the at least one biometric reader capable of capturing and sending biometric information of the user; and
a server adapted to communicate with the at least one biometric reader through the at least one computing device via a communication channel, the server comprising,
a biometric information database pre-storing biometric information of pre-registered users, and
a matching module adapted to communicate with the biometric information database and said computing device,
wherein said matching module is adapted to receive the biometric information of the user, and authorize the transaction based on result of matching of the biometric information of the user with the information stored in the database.

2. The system as claimed in claim 1, wherein the server further comprises a processing module adapted to process the transaction after authorization of the transaction by the matching module.

3. The system as claimed in claim 2, wherein the processing of the transaction comprises settling the transaction with a financial institution.

4. The system as claimed in claim 2 further comprising a database for pre-storing financial information of the users, the financial information oldie user being used during processing of the transaction.

5. The system as claimed in claim 4, wherein the financial information comprises credit card information, bank account information and personal information of the users.

6. The system as claimed in claim 5, wherein the financial information of the user is used for payment of the service or product required by the user.

7. The system as claimed in claim 1, wherein the at least one biometric reader comprises a fingerprint reader.

8. The system as claimed in claim 1, wherein the at least one biometric reader comprises one or more sensors for scanning the biometric information.

9. The system as claimed in claim 1, wherein the biometric information comprises physiological characteristics data and behavioral characteristics data of the users.

10. The system as claimed in claim 1, wherein the at least one biometric reader is adapted to apply a non-reversible compression to the biometric information of the user.

11. The system as claimed in claim 1, wherein the communication channel comprises at least one of a cellular telephone network, a satellite network, a virtual private network and the Internet.

12. A method for implementing biometric authenticated transactions for sale and purchase of various services or products, the method comprising:
receiving a transaction request for at least one service or product from a user through a user computing device;
receiving biometric information of the user through at least one biometric reader connected to the said computing device, wherein the biometric reader is adapted to capture the biometric information of the user;
retrieving a pre-stored biometric information of said user from a biometric information database;
matching the user biometric information with the pre-stored biometric information;
authorizing the received transaction request based on results of matching of the biometric information; and
processing and confirming the transaction to the user.

13. The method as claimed in claim 12, wherein receiving a transaction request from the user comprises,
identifying said user's account,
verifying the said user account,
sending a verification confirmation to the said user computing device, and
receiving said transaction request from the user via the user computing device.

14. The method as claimed in claim 12, wherein receiving biometric information comprises applying a non-reversible compression to the scanned biometric information of the user, the non-reversible compression being applied by the at least one biometric reader for encryption of the biometric information.

15. The method as claimed in claim 12 further comprising retrieving financial information of the user from a database.

16. The method as claimed in claim 15, wherein the financial information comprises credit card information, bank account information and personal information of the said user.

17. The method as claimed in claim 16, wherein processing transaction comprises,
requesting for financial settlement of the transaction with a financial institution,
performing the payment using the financial information of the user, and
sending notification to the user computing device upon completion of the transaction.

18. The method as claimed in claim 12, wherein the at least one biometric reader comprises a fingerprint reader.
